(19) United States
(12) Patent Application Publication
(10) Pub. No.: US 2026/0045563 A1
(43) Pub. Date: Feb. 12, 2026

(54) MODERN BATTERY DESIGN AND CHARGING SYSTEM

(71) Applicant: BKPK, Inc., Phoenix, AZ (US)

(72) Inventor: Dirk Karsten Beth, Phoenix, AZ (US)

(21) Appl. No.: 19/296,802

(22) Filed: Aug. 11, 2025

Related U.S. Application Data
(60) Provisional application No. 63/682,236, filed on Aug. 12, 2024.

(51) Int. Cl. H01M 10/42; B60L 50/64; B60L 53/16; B60L 58/18; B60L 58/26; H01M 10/48; H01M 50/258

(52) U.S. Cl. CPC H01M 10/425; B60L 50/64; B60L 53/16; B60L 58/18; B60L 58/26; H01M 10/482; H01M 50/258; H01M 2220/20

(57) ABSTRACT

A modular portable battery system is disclosed. The modular portable battery includes at least one portable battery module with a battery body coupled to a frame surrounding the battery body and configured to protect the battery body from impact. The frame spaces the battery body from adjacent battery modules to improve ventilation of the battery body. Each battery module is configured to electrically and communicatively couple with adjacent battery modules and coordinate with the adjacent battery modules to power electrical devices.

### RELATED APPLICATIONS

This application claims the benefit of U.S. provisional patent application 63/682,236, filed Aug. 12, 2024, to Dirk Beth, titled “MODERN BATTERY DESIGN AND CHARGING SYSTEM,” the entirety of the disclosure of which is hereby incorporated by this reference.

### TECHNICAL FIELD

This document relates to energy storage and management systems using a modular portable battery system designed to serve as a flexible and easily transportable power source.

### BACKGROUND

Current solutions for portable energy storage often lack the flexibility and user-friendliness required for widespread adoption. For example, existing portable battery packs are typically bulky and designed with a fixed configuration that may not be ideal for all users. Moreover, these systems often require complex connections or installations, limiting their usability and convenience.

The current electric vehicle (EV) infrastructure predominantly focuses on stationary charging solutions and fixed battery systems. This approach poses limitations in scenarios requiring supplementary power sources or extended range, such as long-distance travel or emergency situations. In addition, traditional EV batteries are optimized for vehicle propulsion and are not easily repurposed for other uses.

On the residential front, the integration of renewable energy sources, such as solar panels and wind turbines, has become increasingly prevalent. These systems often require effective energy storage solutions to manage intermittent energy production and consumption. Traditional home battery systems are typically stationary and not easily transferable, which limits their utility in dynamic and evolving energy environments.

### SUMMARY

According to one aspect, a modular portable battery system includes a battery body configured to hold an electrical charge and power an electrical device with the electrical charge; and at least one electrical port on the battery body configured to receive an electrical connector; wherein the battery module is configured to electrically and communicatively couple with adjacent battery modules and coordinate with the adjacent battery modules to power the electrical device.

In various embodiments, the modular portable battery system includes a frame surrounding the battery body and configured to protect the battery body from impact and space the battery body from adjacent battery modules to ventilate the battery body. In some embodiments, the modular portable battery system includes a mounting bracket configured to fixedly mount to a structure, the mounting bracket having at least one clip configured to latch onto the frame to secure the frame and the battery body to the structure. In numerous embodiments, the at least one clip is a plurality of clips and each clip of the plurality of clips is operatively tied to another clip of the plurality of clips such that the plurality of clips opens and closes together. In some embodiments, the battery module is configured to estimate a traveling range of an electric vehicle based on the electric charge of the battery module and on the electric charge of adjacent battery modules. In some embodiments, the battery module is configured to monitor the electrical charge in real-time. In certain embodiments, the battery module is configured to extend a range for an electric vehicle by providing the electrical charge to the electric vehicle while the electric vehicle is in motion.

According to one aspect, a modular portable battery system includes a battery module having a battery body configured to hold an electrical charge and power an electrical device with the electrical charge, the battery body having at least one electrical port configured to receive an electrical connector; and a frame surrounding the battery body and configured to protect the battery body from impact and space the battery body from adjacent battery modules to ventilate the battery body.

In certain embodiments, the modular portable battery system includes a mounting bracket configured to fixedly mount to a structure, the mounting bracket having at least one clip configured to latch onto the frame to secure the frame and the battery body to the structure. In some embodiments, the structure is a building. In numerous embodiments, the structure is a vehicle. In some embodiments, the at least one clip is a plurality of clips and each clip of the plurality of clips is operatively tied to another clip of the plurality of clips such that the plurality of clips opens and closes together. In various embodiments, the battery module is configured to extend a range for an electric vehicle by providing the electrical charge to the electric vehicle while the electric vehicle is in motion. In some embodiments, the at least one electrical port is a J3400 connector port.

According to one aspect, a modular portable battery system includes a battery module having a battery body configured to hold an electrical charge and power an electrical device with the electrical charge; and at least one electrical port on the battery body configured to receive an electrical connector; wherein the battery body has: an inner enclosure containing sensitive components of the battery module, wherein the inner enclosure is hermetically sealed; and an outer enclosure surrounding the inner enclosure, wherein the outer enclosure is offset from the inner enclosure to create a gap between the outer enclosure and the inner enclosure.

In some embodiments, the modular portable battery system includes a frame surrounding the battery body and configured to protect the battery body from impact and space the battery body from adjacent battery modules to ventilate the battery body. In numerous embodiments, the outer enclosure is conductively tied to the inner enclosure to enhance heat transfer from the inner enclosure to the outer enclosure. In some embodiments, the modular portable battery system includes at least one fan positioned in the gap between the outer enclosure and the inner enclosure and configured to enhance heat dissipation from the inner enclosure.

In various embodiments, the battery module is configured to electrically and communicatively couple with adjacent battery modules and coordinate with the adjacent battery modules to power the electrical device. In some embodiments, the battery module is configured to estimate a traveling range of an electric vehicle based on the electric charge of the battery module and on the electric charge of adjacent battery modules.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIGS. 1A and 1B are a representation of a modular portable battery system;

FIGS. 2A & 2B are representations of a modular portable battery system;

FIGS. 3A-3C are representations of a modular portable battery system;

FIGS. 4A-4E are representation of clips;

FIG. 5 is a representation of a battery body; and

FIGS. 6A and 6B are representations of communications of a modular portable battery system.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

This document relates to energy storage and management systems, specifically to a modular portable battery system designed to serve as a flexible, easily transportable power source. More precisely, it pertains to a portable battery system akin to a jerry can but adapted for use with electric vehicles (EVs) and other applications where portable energy storage is required, and energy storage may be portable, modular, or both.

A jerry can, traditionally used for storing and transporting liquid fuels, is renowned for its ease of handling and portability. Adapting this concept to energy storage, a modular portable battery system designed to act as a jerry can for EVs offers several advantages. Such a system is lightweight, durable, and easily transportable, providing a practical solution for supplemental power needs in the context of EVs and beyond.

Different from current batteries used in EV vehicles and from current batteries used in homes, the present disclosure is related to battery systems that not only power vehicles but also provide additional functionalities, such as grid stabilization and energy storage for home use. A modular, portable battery system 100 that can be connected to a home's electrical network provides homeowners with greater flexibility and control over their energy resources. Thus, the present disclosure is related to the development of modular portable battery systems 100 that can seamlessly integrate with electric vehicles, residential energy networks, other modular portable battery systems 100, and other electric devices.

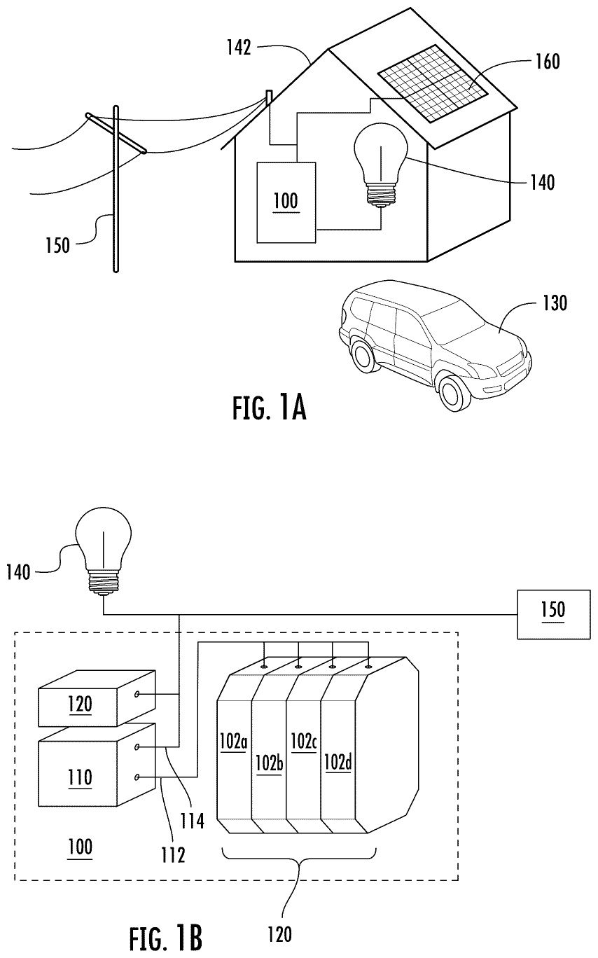

FIGS. 1A and 1B depict various embodiments of a modular portable battery system 100. Battery system 100 can be installed in a user's workplace, home 142, garage, or other building. Electric power is delivered to a home 142 for use in the residential energy network 140 typically from an external power grid 150 (e.g., local power company distributing power lines throughout a city, microgrid, and so forth). Residential energy network 140 may be a household electrical network, a multiplex or apartment electrical network, a business electrical network, a microgrid, and so forth. An on-site power supply 160 can supplement or replace the external grid 150 depending on the capacity, usage needs, and configuration of the on-site power supply 160, which may include photovoltaic panels, gas generator(s), wind turbine(s), wind turbine(s), or other power supplies. Most homeowners own a vehicle 130, which is historically a conventional internal combustion engine (ICE) vehicle but increasing numbers of homeowners are purchasing electric vehicles (EV) (e.g., battery electric vehicles, plug-in hybrid electric vehicles, extended-range electric vehicles, or other electric vehicles), so the vehicle 130 may be an EV, ICE vehicle, or other vehicle. In some embodiments, vehicle 130 is an electric motorcycle, bicycle, scooter, tricycle, skateboard, or other vehicle other than a four-wheeled car, truck, van, or the like.

Battery system 100 has portable and modular battery modules 102 according to various embodiments of this disclosure. Battery system 100 also includes a converter 110 and a controller 120 for managing and controlling power management of the battery system 100. The modular battery module(s) 102 may comprise a single battery module 102 or multiple battery modules 102, such as the four battery modules 102a-102d shown in FIG. 1B or another amount of multiple battery modules 102. Converter 110 can be, for example, one of various types of DC-AC converters, inverters, converter/inverter, converter/inverter/rectifier combos, power optimizers, string inverters, and so forth. Converter 110 has the ability to change the form of electrical energy (e.g., voltage, current, DC to AC, AC to DC, etc.) from the input 112 to the output 114 of the converter 110. Converter 110 may be a mobile component similar to a battery module 102 or may be generally stationary after installing and connecting battery system 100 to the residential energy network 140. Controller 120 executes instructions for the management of power transfer, recharging, and other control and management elements of battery system 100. Controller 120 may be attached to or integrated with converter 110 and may be mobile or generally stationary upon completion of installation. Controller 120 may be: fully or partially housed in battery module(s) 102, a series of redundant or dispersed controllers 120 located both inside battery module(s) 102 and outside (e.g., adjacent or in converter 110), or otherwise communicatively coupled to battery system 100 with the ability to control and manage power transfer. In some embodiments, controller 120 comprises multiple controllers dispersed between multiple battery modules 102 that communicate and coordinate using artificial intelligence (AI) swarm logic, distributive computation, load sharing, or other collaborative logic techniques.

According to some embodiments, converter 110 is not included in portable modular battery system 100. For example, battery system 100 would include one or more battery modules 102, but not a system-wide converter (e.g., converter 100) stationed at the residential energy network 140 or similar energy network. Thus, a user could recharge battery modules 102 by plugging in a battery module 102 to residential energy network 140, a photovoltaic charging point, a hybrid vehicle 130, an EV charging station, or any other charging point. In some embodiments, each battery module 102 has its own converter 110 and controller 120 sufficient to operate on a standalone basis without a centralized converter 110 or controller 120.

The concept of modular portability for battery system 100 addresses several critical needs in today's energy landscape. A battery system 100 that is modular and portable can be easily transported and deployed in various settings, offering advantages for both vehicle owners and homeowners. For EV 130 owners, battery system 100 can serve as an auxiliary power source during long trips or emergencies, as well as facilitate vehicle-to-grid (V2G) applications where the battery of vehicle 130, the battery system 100, or both, contribute to electric stability of one or both of the residential energy network 140 or the external grid 150. For homeowners, the ability to connect a portable battery system 100 to their residential energy network 140 enhances their capability to store and manage energy more efficiently, particularly during peak demand periods or power outages. The portable battery system 100 may also be used for off-the-grid activities such as while camping. The presently disclosed battery system 100 integrates communication capabilities, onboard compute for AI, and swarm functionality. Additionally, it features application software for planning and monitoring. The hardware includes a protective cage or frame, reduction in susceptible features, and a multi-purpose design. Real-time integration with vehicle 130 systems enhances performance of the battery system 100.

For example, real-time integration with vehicle 130 systems may mean that when the battery system 100 is loaded onto, coupled with, or integrated with a vehicle 130, the battery system 100 becomes an additional power source available to the vehicle 130 to be used while driving. Thus, rather than requiring the user to stop and switch out a battery or recharge the vehicle's 130 onboard battery, the battery system 100 automatically couples with and powers the vehicle 130 in real-time. As an example, in some instances the power from a battery module 102 can be the main power source and directly power the vehicle 130 without: being separately stored in the vehicle's 130 original power system, or without first recharging the vehicle's 130 original power system. Powering the vehicle's 130 original power system may occur by being routed outside the vehicle's 130 original power system or by being routed through the vehicle's 130 original power system. For clarity, power transfer from the battery module(s) 102 or battery system 100 without separate power storage in the vehicle's 130 original power system may, in some instances, include some power cycling through existing power storage or batteries, such as less than a percentage of the original power storage capacity of the vehicle's 130 original power system where the percentage is less than or equal to 50%, 40%, 30%, 20%, 10%, 5%, 3%, 2%, 1%, or 0.5%. In any instance, real-time integration of the battery module(s) 102 and the vehicle 130 will allow the vehicle 130 to draw power from (or use a battery module 102) while driving. This real-time integration can be initiated while vehicle 130 is in motion and can be initiated with a command, such as by voice, flip of a switch, or by push or a button.

In some embodiments, the modular portable battery system 100 is configured to extend a range for an electric vehicle 130. The range of the vehicle 130 is extended by connecting at least one battery module 102 of the battery system 100 to the electric vehicle 130, thus allowing the electric vehicle 130 to use the electric charge within the battery module(s) 102 to travel a farther distance than would otherwise be possible. Thus, the battery system 100 disclosed herein is a range extender for electric vehicles 130.

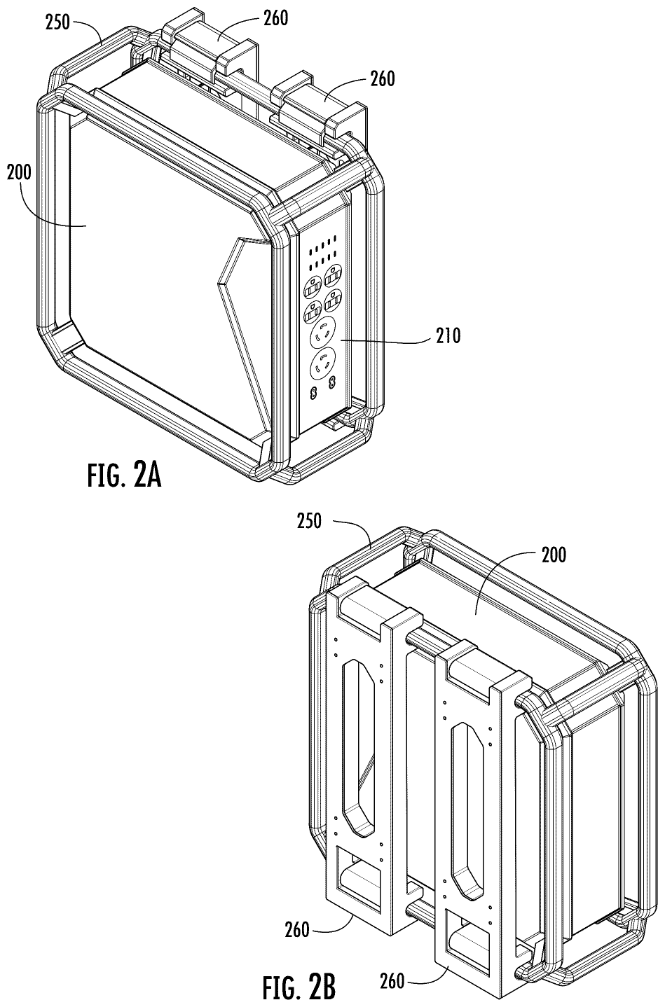

As shown in FIGS. 2A and 2B, in some embodiments, the modular portable battery system 100 comprises a battery module 102 having a battery body 200. Each battery module 102 can include a frame 250 coupled to the battery body 200. The battery system 100 may utilize one or more clips 260 to secure and hold battery module(s) 102 in position within battery system 100 or during portable use of battery module(s) 102 (e.g., clip(s) 260 installed on: a vehicle 130, camping trailer, farmer's market tent setup, remote computer workstation, military components, and so forth).

In some embodiments, the modular portable battery system 100 has a cage or frame 250 that surrounds the battery body 200. The frame 250 is configured to protect the battery body 200 from impact and also spaces the battery body 200 from adjacent battery modules 102 or modular portable battery systems 100. This helps to ventilate around the battery body 200 and thus dissipate heat from the battery body 200. The frame 250 may also provide a convenient structure for the clips 260 described herein to latch onto to secure the battery module(s) 102 to a structure such as a building (e.g., home 142) or vehicle (e.g., vehicle 130). The frame 250 may also be used as a handle for one- or two-person carrying.

In various embodiments, the battery body 200 is configured to house rechargeable battery cells to hold an electrical charge and power an electrical device with the electrical charge. To this end, the battery body 200 may have at least one electrical port 210 configured to receive an electrical connector (e.g., the connector end of a cord, a plug, a male end of an electrical connector, or other electrical connector). Electrical port(s) 210 may include a variety of electrical connections including, for example, plugs with a domestic United States focus may include National Electrical Manufacturers Association (NEMA) standardized plugs NEMA 5-15, NEMA 5-20, NEMA 6-15, NEMA 6-20, NEMA 14-30, NEMA TT-30, NEMA L6-30, NEMA 14-50, NEMA 6-50, NEMA 15-60 or 15-x for other amperages, NEMA 18-60 or 18-x for other amperages, and so forth. In some embodiments, electrical port(s) 210 include one or more receptacles or plugs according to international standards or national standards (e.g., plug types A, B, C, D, E, F, G, H, I, J, K, L, M, N, 0, or others). In various embodiments, the electrical port(s) 210 may include lower voltage or lower amperage ports including, for example, USB-C, USB 3.0/3.1, USB 4.0, USB 1.0/2.0, and so forth. Electrical port(s) 210 can be any among a wide variety of electrical connection ports, such as banana, spade, ring, pin, bullet connectors or electrical port types yet to be developed. In some embodiments, electrical port 210 may be a North American Charging Standard (NACS) port like the SAE J3400 connector port or another port designed for communications or power.

The battery system 100 disclosed herein may be configured to power an electric vehicle 130, a residential energy network 140 (e.g., a home 142, a business, a cabin, a building, etc.), or any individual electric device. In addition, the battery system 100 disclosed herein is configured to seamlessly integrate with any of these systems simply by connecting the battery system with the desired system (e.g., residential energy network 140, vehicle 130, various electric devices, and so forth). For example, the battery system 100 may be connected to an electric vehicle 130, used to power the electric vehicle 130 for a time, and then connected to a residential energy network 140 and used to power the residential energy network 140 instead. In some embodiments, the battery system 100 may also be charged by any of the systems mentioned herein (e.g., residential energy network 140, vehicle 130, electric devices, and so forth), depending on what is needed. The battery system 100 may be controllable wirelessly, such as through Bluetooth, to give the user control over whether power is provided to the electric device or drawn from the electric device to charge the battery system 100.

The battery body 200 is designed with a reduction in susceptible features to improve the durability of the individual battery modules 102 of the battery system 100. For example, in some embodiments of the battery system 100, the battery body 200 does not have any screens, vents, fans or buttons. In addition, only the necessary electrical port(s) 210 may be provided for charging and daisy chaining of the various battery modules 102 and systems together. This reduces the risk of damage from water, sand, dirt, dust, and impact compared to other battery systems. The electrical port(s) 210 that are available may have seals against water, mud, and other anticipated grime.

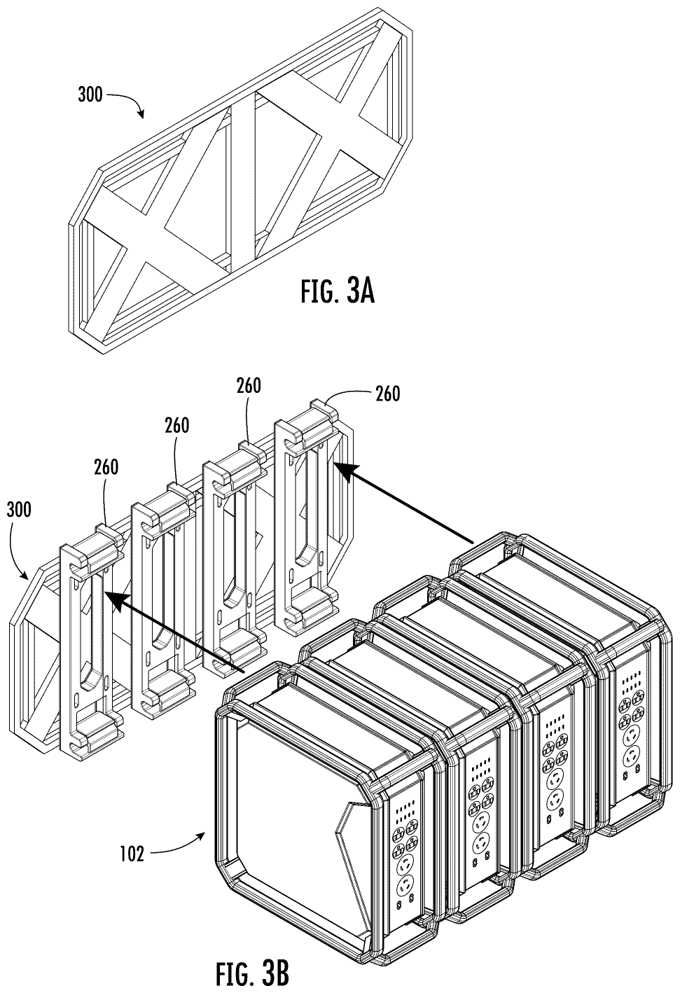

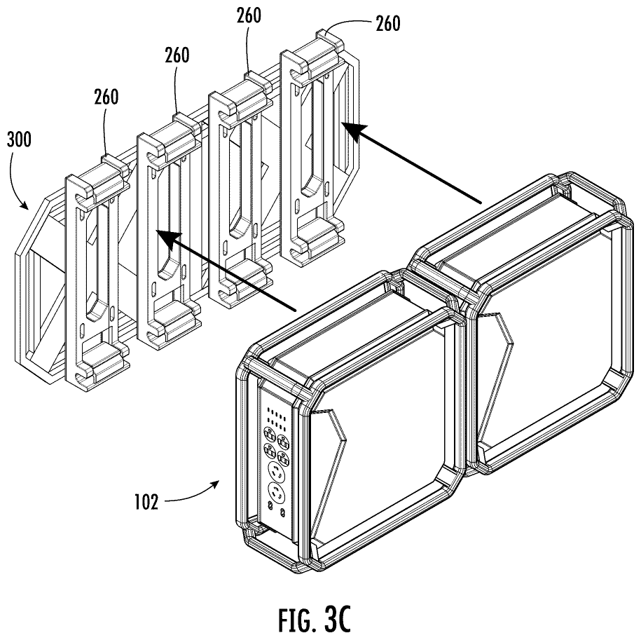

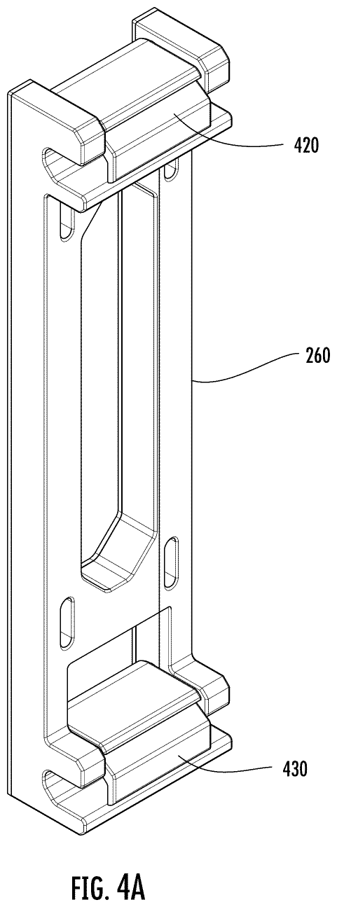

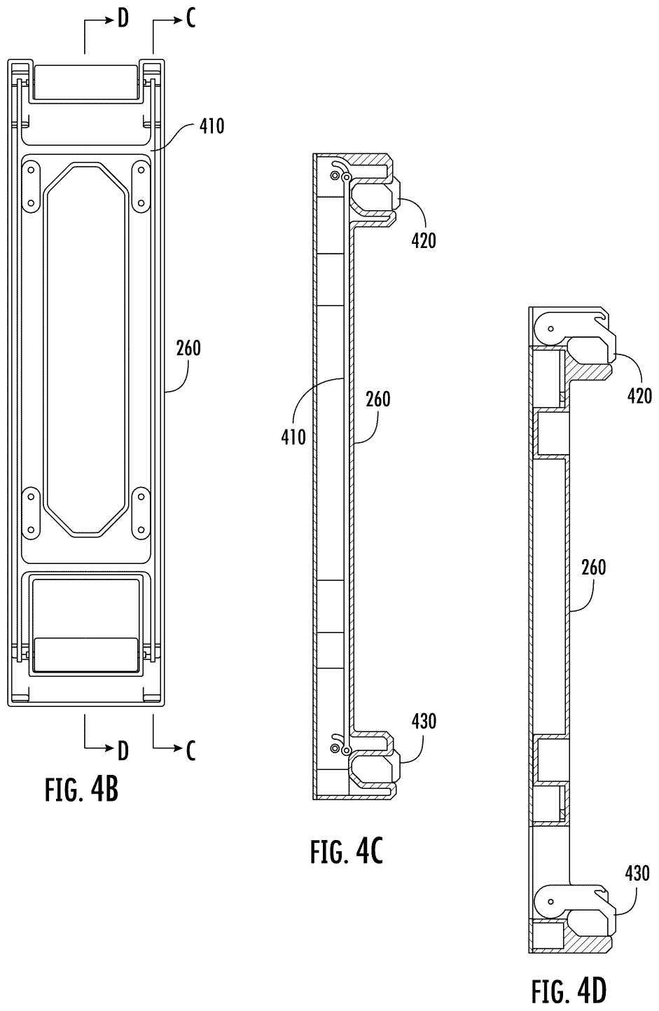

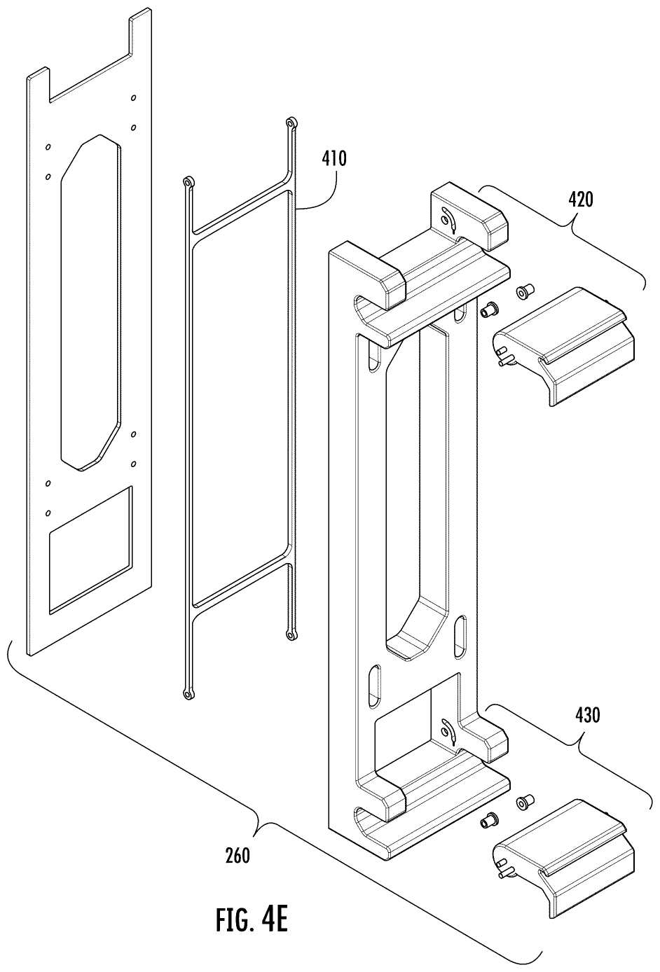

To aid in seamless integration of the battery system 100 with different systems, the battery system 100 may comprise a mounting bracket 300, shown in FIGS. 3A-3C. The mounting bracket 300 is configured to fixedly mount to a structure, such as a building or a vehicle (e.g., vehicle 130). The mounting bracket 300 is configured to attach to the battery system 100 to secure the battery module(s) 102 to the structure. FIG. 3A depicts an example of a mounting bracket 300 alone without any clips 260 or battery module(s) 102 attached. For example, a battery module 102 can attach to clips 260 of the mounting bracket 300 along a short edge of the battery module 102 (see FIG. 3B) or along a long edge of the battery module 102 (see FIG. 3C). In some embodiments, the mounting bracket 300 has at least one clip 260 that is configured to latch onto the battery module 102, as described above and shown in FIGS. 4A-4E. The at least one clip 260 may be a plurality of clips 260, where each clip 260 is operatively tied to another clip 260 of the plurality of clips 260 such that the plurality of clips 260 opens and closes together. For example, a clip 260 can utilize a linkage 410 to mechanically actuate a top clip member 420 and a bottom clip member 430 to operate together when a battery module 102 clips into clip 260.

As mentioned above, the battery system 100 disclosed herein is configured to easily connect and disconnect with any of a plurality of electrical devices, including an electric vehicle 130, a residential energy network 140, on-site power supply 160, external grid 150, or any other electrical device. In addition, the battery system 100 is configured to easily connect with other battery systems 100. Multiple of the presently disclosed battery systems 100 may therefore be combined to be used together, as will be discussed in more detail below. The seamless integration of the battery system 100 with additional battery systems 100 (or other battery systems) increases the value and utility of the presently disclosed battery system 100 and is an improvement over conventional battery systems.

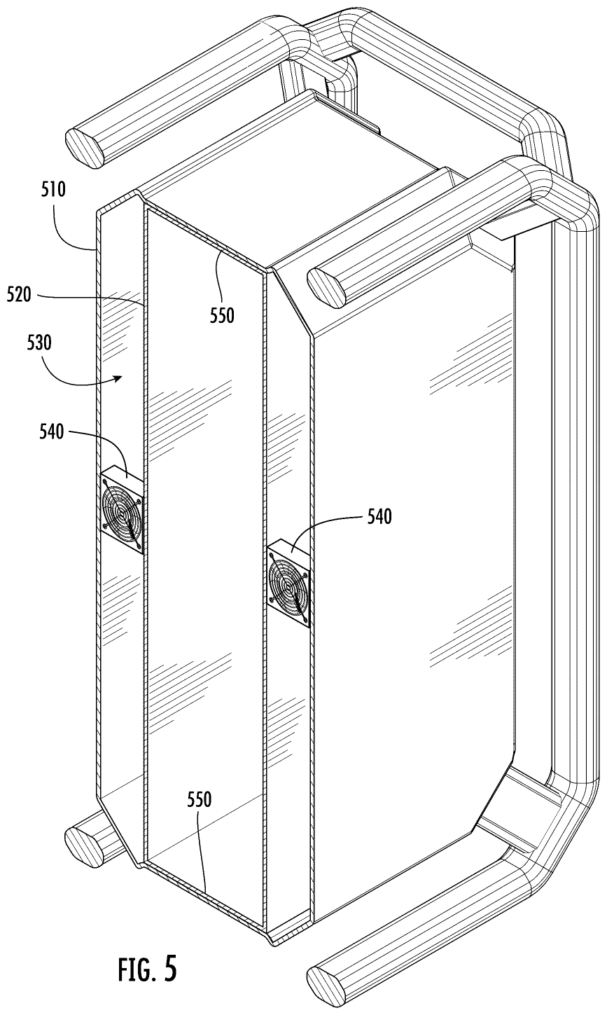

As illustrated in FIG. 5, in some embodiments, the battery body 200 may have a dual enclosure construction designed to improve thermal management while ensuring water resistance. Thus, the modular portable battery system 100 may have an inner enclosure 510 and an outer enclosure 520 for each battery module 102. The inner enclosure 510 is configured to contain the sensitive components of the battery module 102, such as the battery cells, the power electronics, the compute modules, etc. The inner enclosure 510 may be hermetically sealed to protect these sensitive components from contaminants, such as dust and water. The outer enclosure 520 surrounds the inner enclosure 510. External connectors and attachment points (e.g., where frame 250 attaches to outer enclosure 520), and electrical port(s) 210 on the outer enclosure 520 may have impermeable seals and optionally detachable watertight covers for operational use of the electrical port(s) 210. The dual enclosure design facilitates both passive and active cooling methods by creating an intermediary space 530 between the inner 510 and outer enclosures 520. This intermediary space 530 allows for strategic air ducting, optimizing heat dissipation in cooling the battery module 102. Additionally, the inner enclosure 510 is positioned against the outer enclosure 520 in specific areas to enhance heat transfer. Powered active cooling, supported by waterproof fans and sealed or wireless power connections, can also be accommodated within this intermediary space 530 (e.g., fan 540 depicted in FIG. 5).

As mentioned above, the outer enclosure 520 is configured to assist with heat dissipation from the inner enclosure 510. The outer enclosure 520 may be offset from the inner enclosure 510, creating a gap or intermediary space 530 between the outer enclosure 520 and the inner enclosure 510. In some embodiments, the battery system 100 comprises at least one fan 540, which may be waterproof, positioned in the intermediary space 530 between the outer enclosure 520 and the inner enclosure 510. The fan 540 is configured to enhance heat dissipation from the inner enclosure 510 by increasing air circulation and ventilation around the inner enclosure 510. In some embodiments, the outer enclosure 520 is conductively tied by thermal bridges 550 to the inner enclosure 510 across the intermediary space 530 to enhance heat transfer from the inner enclosure 510 to the outer enclosure 520. Thermal bridges 550 can be areas where inner enclosure 510 is elongated to touch outer enclosure 520. Thermal bridges 550 can be a variety of three-dimensional shapes and be arrayed in various patterns depending on the amount of heat to be passed from inner enclosure 510 to outer enclosure 520. As noted above, the frame 250 also helps with heat dissipation by spacing multiple battery modules 102 apart so that proper ventilation and air circulation is maintained even when a large number of battery modules 102 are mounted to a vehicle (e.g., vehicle 130) or building (e.g., home 142).

The battery module(s) 102 of the modular portable battery system 100 may have an electrical port 210 as discussed above. In some embodiments, the electrical port 210 is configured to transmit and receive both electrical power and a communications signal therethrough. This allows multiple battery systems 100 or battery modules 102 to communicate with each other when connected to each other through the electrical port 210. In some embodiments, the electrical port 210 is a J3400 connector port. The electrical port 210 may be a standardized port, such as SAE J3400 or NACS, which enable integrating the battery systems 100 with each other and additional components such as inverters and converters tailored for low-voltage applications.

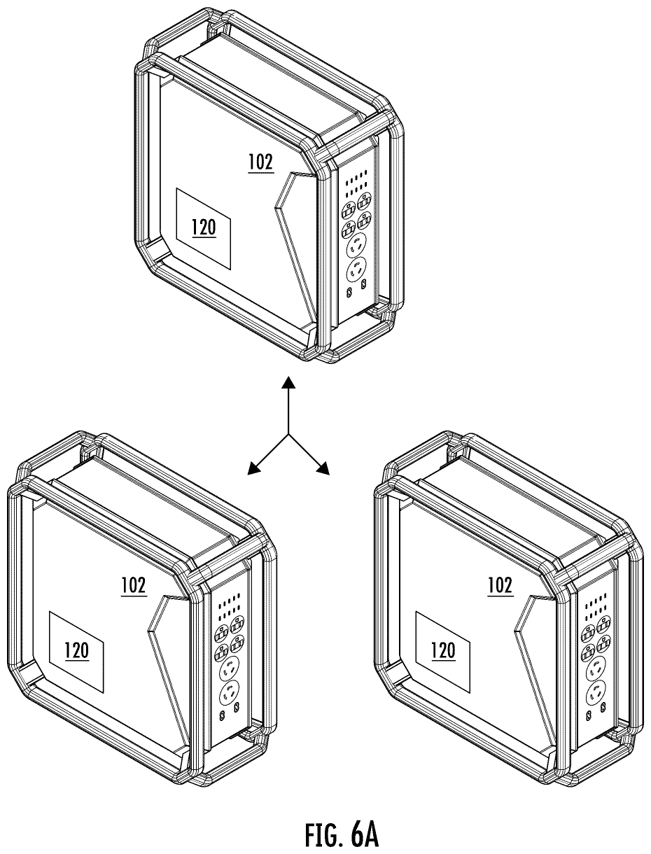

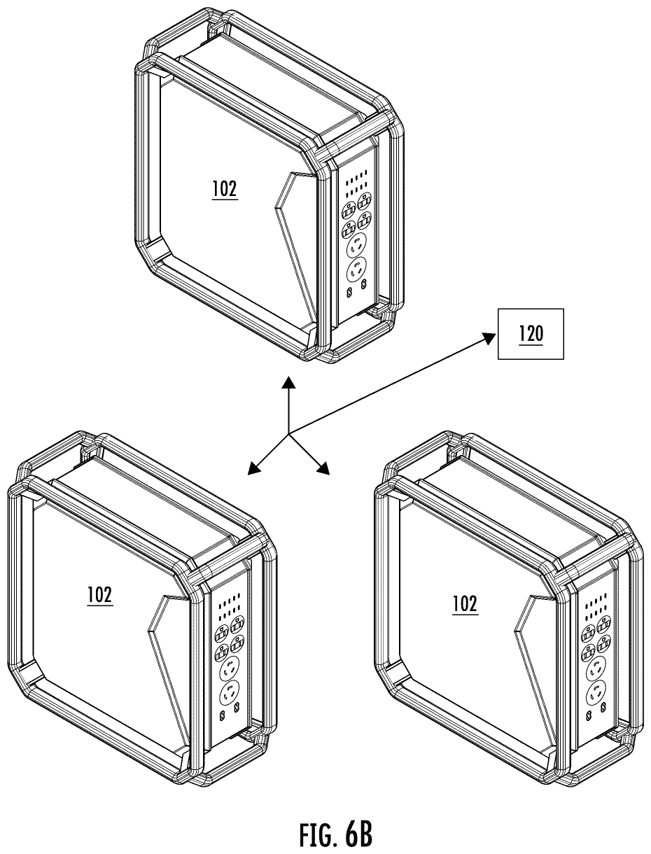

FIGS. 6A and 6B depict numerous non-limiting aspects and embodiments of communication and coordination between battery modules 102 and elements of modular portable battery system 100. The battery system 100 may be a high-voltage system (such as 400V) that can be interconnected with other battery systems 100 to enhance storage capacity while also integrating with an accompanying inverter/converter 110 accessory system. Despite the absence of an established standard connector capable of enduring high cycle rates for such voltage levels, the present disclosure may implement dual J3400 connectors on each pack—commonly used within EV charging infrastructure—to circumvent this limitation. Thus, each battery module 102 may feature two J3400 electrical ports 210 enabling bidirectional connectivity amongst multiple battery modules 102 or between battery modules 102 and accessories without necessitating specific connector usage by end-users. On-board logic (e.g., controller 120) coupled with power electronics ensures correct directional flow of electricity, making the battery system 100 foolproof for users and significantly enhancing safety.

The modular portable battery system 100 disclosed herein may also be equipped with software for power management using controller 120. The controller 120 software may allow a user to 1) manage and configure individual devices or battery modules 102, 2) plan the energy uses of an activity based on various inputs such as power consuming devices, power supply available over time, etc. and 3) monitor the planned activity once the activity is underway to ensure that the user can take action if there is a variance in the energy needs of the activity. These capabilities are only possible due to the integration between the swarm and swarm members, the application logic, and the AI running across the entirety of the battery system 100. In some embodiments, controller 120 is housed on each or two or more of numerous battery modules 102 (e.g., FIG. 6A), while other embodiments rely on controller 120 of battery system 100 that is separate from one or more of the battery modules 102 (e.g., FIG. 6B).

The battery modules 102 of battery system 100 may be configured to “swarm” with adjacent connected battery modules 102 or battery systems 100. This means that the battery modules 102 work together toward a common goal without necessarily having a particular device, controller 120, or battery module 102 in charge. Instead, the battery modules 102 work together to identify the most efficient way to accomplish the goal and then execute this plan. For example, multiple battery modules 102 may be connected to an electric vehicle 130. The battery modules 102 may share the power load of the electric vehicle 130 so that all battery modules 102 remain at least partially charged for as long as possible. The battery modules 102 may also report to the user the amount of power available or a range that the user can travel using the available power. As another example, multiple battery modules 102 may be connected to a residential energy network 140. As the power load on the residential energy network 140 changes, such as when air conditioning turns on or off or other electrical devices are connected, the battery modules 102 may work together to ensure that all electrical power needs are met. The battery modules 102 may also determine that a particular battery module 102 needs to be recharged and therefore relieve that battery module 102 of any power load to allow the battery module 102 to recharge from a power source while the remaining battery modules 102 continue to power the residential energy network 140. Other examples of the utility of the battery module 102 swarm will be apparent to one of skill in the art.

The swarm technology and distributed energy management across the battery management system (BMS) of the controller 120 and battery modules 102 of all the swarm members allows the modular battery system 100 to work together as a home energy backup battery, a portable EV range extender, or a portable battery for worksite, industrial, or recreational power supply. The energy management system (EMS) software uses learning and AI to optimize the performance and efficiency of the swarm based on the task that the swarm is doing. The swarm can also determine the task based on inputs such as energy usage and demand.

The application software of the battery system 100 may also be configured to assist with planning for power consumption. For example, the battery module 102, through the application software, may be configured to provide an estimate for the range of an electric vehicle 130 based on the available power, and therefore make suggestions for when and where to stop to recharge the battery module 102. If an additional battery module 102 is connected, the battery modules 102 may be configured to automatically update this plan based on the increased amount of power available, and therefore the increased range. The user may desire to input an amount of power that should be available at the end of the journey, and the battery module 102 is configured to take this into account in planning for power consumption throughout the trip. The battery module 102 may also be configured to monitor power consumption in real-time.

As mentioned above, the presently disclosed battery system 100 may have a smart battery management system that has WIFI, Bluetooth, Thread, UWB, RJ45, and J3400 connectivity on-board. One or more of these connections at any time can be used for inter-device communications, swarm compute, remote software update, and communications to a mobile device or computer. The battery system 100 and each battery module 102 may have sufficient compute to support AI processing and swarm capability. This compute may also be distributed when in a swarm. With this connectivity, the swarm can communicate amongst all the swarm participants. One or more of the members of the swarm can provide data back to a mobile device providing data on the swarm and all the swarm members' performance. A swarm may be made up of several different energy storage devices (e.g., battery modules 102) and their BMSs. The swarm may also include other devices that use energy from the energy storage devices and energy producers like a user's grid-connected (e.g., external grid 150) or solar home (e.g., on-site power supply 160).

The software of the battery system 100 and battery modules 102 may be configured to integrate with connected software systems such as of a vehicle 130. For example, the battery system 100 may be configured to integrate its data into the human machine interface (HMI) systems of common vehicles 130 so that the operator or passenger can monitor the battery system 100 from the vehicle HMI.

The modular portable battery system 100 disclosed herein is useful in a wide variety of applications. For example, the battery system 100 may be used in camping, marine applications, home maintenance, communications equipment, off-the-grid use, mining and construction applications, as a home backup, in defense, or in mobile robotics. Other applications will be apparent to one of skill in the art.

The modularity of the battery system 100 disclosed herein is supported by the size and weight of each battery module 102. The dimensions of each battery module 102 are easily manipulated by a person but can be integrated to support a large energy storage system. The design of each battery module 102 includes a cage or frame 250 that supports the carrying and manipulation of each battery module 102 by either one or two people. The frame 250 also supports a way to securely connect the battery module 102 to a rack (e.g., a rack with clips 260) for storage, locking, and noise, vibration, and harshness during transport or to a mounting bracket 300. In addition, the battery system 100 can be supported by accessories (e.g., converter 110) that allow for integration into the home 142 as a home backup or that allow for additional standard 110V, 220V, and USB connectors.

Modular portable battery systems 100 and their battery modules 102 represent a significant innovation in energy management, combining the benefits of flexibility, scalability, and efficiency. These battery modules 102 are designed to be easily reconfigured and integrated with existing infrastructure, offering a scalable solution that can adapt to various energy needs. They also support advancements in energy technologies and contribute to a more resilient and sustainable energy ecosystem.

In summary, the development of modular portable battery systems 100 that are compatible with both electric vehicles 130 and residential energy networks 140 addresses a crucial need in the evolving landscape of energy storage and management. By enhancing the functionality and versatility of battery systems 100, this innovation supports the broader goals of energy efficiency, sustainability, and resilience.

It will be understood that implementations of the modular portable battery system 100 include but are not limited to the specific components disclosed herein, as virtually any components consistent with the intended operation of various modular portable battery systems may be utilized. Accordingly, for example, it should be understood that, while the drawings and accompanying text show and describe particular modular portable battery system 100 implementations, any such implementation may comprise any shape, size, style, type, model, version, class, grade, measurement, concentration, material, weight, quantity, and/or the like consistent with the intended operation of modular portable battery systems 100.

The concepts disclosed herein are not limited to the specific modular portable battery system 100 shown herein. For example, it is specifically contemplated that the components included in particular modular portable battery systems 100 may be formed of any of many different types of materials or combinations that can readily be formed into shaped objects and that are consistent with the intended operation of the modular portable battery system 100. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, modular portable battery systems 100 may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular modular portable battery system 100 implementations, it should be readily apparent that a number of modifications may be made without departing from the spirit thereof and that these implementations may be applied to other implementations disclosed or undisclosed. The presently disclosed modular portable battery systems 100 are, therefore, to be considered in all respects as illustrative and not restrictive.

I claim:

1. A modular portable battery system, comprising:
a battery body configured to hold an electrical charge and power an electrical device with the electrical charge; and
at least one electrical port on the battery body configured to receive an electrical connector;
wherein the battery module is configured to electrically and communicatively couple with adjacent battery modules and coordinate with the adjacent battery modules to power the electrical device.

2. The modular portable battery system of claim 1, further comprising a frame surrounding the battery body and configured to protect the battery body from impact and space the battery body from adjacent battery modules to ventilate the battery body.

3. The modular portable battery system of claim 2, further comprising a mounting bracket configured to fixedly mount to a structure, the mounting bracket having at least one clip configured to latch onto the frame to secure the frame and the battery body to the structure.

4. The modular portable battery system of claim 3, wherein the at least one clip is a plurality of clips and each clip of the plurality of clips is operatively tied to another clip of the plurality of clips such that the plurality of clips opens and closes together.

5. The modular portable battery system of claim 1, wherein the battery module is configured to estimate a traveling range of an electric vehicle based on the electric charge of the battery module and on the electric charge of adjacent battery modules.

6. The modular portable battery system of claim 1, wherein the battery module is configured to monitor the electrical charge in real-time.

7. The modular portable battery system of claim 6, wherein the battery module is configured to extend a range for an electric vehicle by providing the electrical charge to the electric vehicle while the electric vehicle is in motion.

8. A modular portable battery system, comprising:
a battery module having a battery body configured to hold an electrical charge and power an electrical device with the electrical charge, the battery body having at least one electrical port configured to receive an electrical connector; and
a frame surrounding the battery body and configured to protect the battery body from impact and space the battery body from adjacent battery modules to ventilate the battery body.

9. The modular portable battery system of claim 8, further comprising a mounting bracket configured to fixedly mount to a structure, the mounting bracket having at least one clip configured to latch onto the frame to secure the frame and the battery body to the structure.

10. The modular portable battery system of claim 9, wherein the structure is a building.

11. The modular portable battery system of claim 9, wherein the structure is a vehicle.

12. The modular portable battery system of claim 9, wherein the at least one clip is a plurality of clips and each clip of the plurality of clips is operatively tied to another clip of the plurality of clips such that the plurality of clips opens and closes together.

13. The modular portable battery system of claim 8, wherein the battery module is configured to extend a range for an electric vehicle by providing the electrical charge to the electric vehicle while the electric vehicle is in motion.

14. The modular portable battery system of claim 8, wherein the at least one electrical port is a J3400 connector port.

15. A modular portable battery system, comprising:
a battery module having a battery body configured to hold an electrical charge and power an electrical device with the electrical charge; and
at least one electrical port on the battery body configured to receive an electrical connector;
wherein the battery body has:
an inner enclosure containing sensitive components of the battery module, wherein the inner enclosure is hermetically sealed; and
an outer enclosure surrounding the inner enclosure, wherein the outer enclosure is offset from the inner enclosure to create a gap between the outer enclosure and the inner enclosure.

16. The modular portable battery system of claim 15, further comprising a frame surrounding the battery body and configured to protect the battery body from impact and space the battery body from adjacent battery modules to ventilate the battery body.

17. The modular portable battery system of claim 16, wherein the outer enclosure is conductively tied to the inner enclosure to enhance heat transfer from the inner enclosure to the outer enclosure.

18. The modular portable battery system of claim 16, further comprising at least one fan positioned in the gap between the outer enclosure and the inner enclosure and configured to enhance heat dissipation from the inner enclosure.

19. The modular portable battery system of claim 16, wherein the battery module is configured to electrically and communicatively couple with adjacent battery modules and coordinate with the adjacent battery modules to power the electrical device.

20. The modular portable battery system of claim 15, wherein the battery module is configured to estimate a traveling range of an electric vehicle based on the electric charge of the battery module and on the electric charge of adjacent battery modules.
